(19) United States
(12) Patent Application Publication
(10) Pub. No.: US 2024/0272639 A1
(43) Pub. Date: Aug. 15, 2024

(54) INFORMATION PROCESSING APPARATUS, SYSTEM, MOBILE OBJECT, METHOD AND STORAGE MEDIUM

(71) Applicant: KABUSHIKI KAISHA TOSHIBA, Tokyo (JP)

(72) Inventors: Satoshi TAKAYA, Kawasaki Kanagawa (JP); Hiroaki ISHIHARA, Yokohama Kanagawa (JP)

(73) Assignee: KABUSHIKI KAISHA TOSHIBA, Tokyo (JP)

(21) Appl. No.: 18/482,115

(22) Filed: Oct. 6, 2023

(30) Foreign Application Priority Data
Feb. 15, 2023 (JP) 2023-021713

(51) Int. Cl. G05D 1/02

(52) U.S. Cl. CPC G05D 1/0289

(57) ABSTRACT

According to one embodiment, an information processing apparatus includes a first processing circuit. The first processing circuit is configured to specify a first route along which a first mobile object is moving in a case where a state signal regarding a state of the first mobile object moving based on a first control signal regarding movement of the first mobile object is not received, specify a second mobile object different from the first mobile object based on the specified first route, and generate a second control signal regarding movement of the specified second mobile object.

### CROSS-REFERENCE TO RELATED APPLICATIONS

This application is based upon and claims the benefit of priority from Japanese Patent Application No. 2023-021713, filed Feb. 15, 2023, the entire contents of which are incorporated herein by reference.

### FIELD

Embodiments described herein relate generally to an information processing apparatus, a system, a mobile object, a method, and a storage medium.

### BACKGROUND

In recent years, it has been known to provide various services by controlling mobile objects such as an autonomous mobile robot (AMR) and an automatic guided vehicle (AGV).

However, in a case where the mobile object performs an unintended operation, there is a possibility that a surrounding structure or person is damaged.

Thus, there is a demand for a mechanism for suppressing a decrease in safety due to the unintended operation of the mobile object.

### BRIEF DESCRIPTION OF THE DRAWINGS

FIG. 1 is a diagram for describing an outline of a mobile robot system according to an embodiment.

FIG. 2 is a diagram illustrating an example of a functional configuration of an information processing apparatus.

FIG. 3 is a diagram illustrating an example of a system configuration of the information processing apparatus.

FIG. 4 is a diagram illustrating an example of a functional configuration of a mobile robot.

FIG. 5 is a diagram illustrating an example of a configuration of a communication state detection module on the information processing apparatus side.

FIG. 6 is a diagram illustrating an example of a configuration of a communication state detection module on the mobile robot side.

FIG. 7 is a flowchart illustrating an example of a processing procedure of the information processing apparatus.

FIG. 8 is a diagram for specifically describing an operation of the communication state detection module on the information processing apparatus side.

FIG. 9 is a flowchart illustrating an example of a processing procedure of the mobile robot.

FIG. 10 is a diagram for specifically describing an operation of the communication state detection module on the mobile robot side.

FIG. 11 is a diagram for describing safety in the mobile robot system.

FIG. 12 is a flowchart illustrating an example of a processing procedure of the information processing apparatus when the movement of the mobile robot is resumed.

FIG. 13 is a flowchart illustrating an example of a processing procedure of the information processing apparatus in a case where a route of the mobile robot is changed.

FIG. 14 is a diagram for describing safety in a case where the route of the mobile robot is changed.

### DETAILED DESCRIPTION

In general, according to one embodiment, an information processing apparatus includes a first processing circuit. The first processing circuit is configured to specify a first route along which a first mobile object is moving in a case where a state signal regarding a state of the first mobile object moving based on a first control signal regarding movement of the first mobile object is not received, specify a second mobile object different from the first mobile object based on the specified first route, and generate a second control signal regarding movement of the specified second mobile object.

Various embodiments will be described with reference to the accompanying drawings.

The information processing apparatus according to the present embodiment is used to control the mobile object moving in a predetermined space (hereinafter, referred to as a target space) such as a warehouse or a factory. Note that, it is assumed that the mobile object in the present embodiment is, for example, an autonomous traveling conveyance robot (AJR), an automated guided vehicle (AGV), a drone, or the like, but may be another mobile object. In the following description, it is assumed that the mobile object is a mobile robot (for example, AMR), but the present embodiment is similarly applicable to a mobile object controlled by the information processing apparatus.

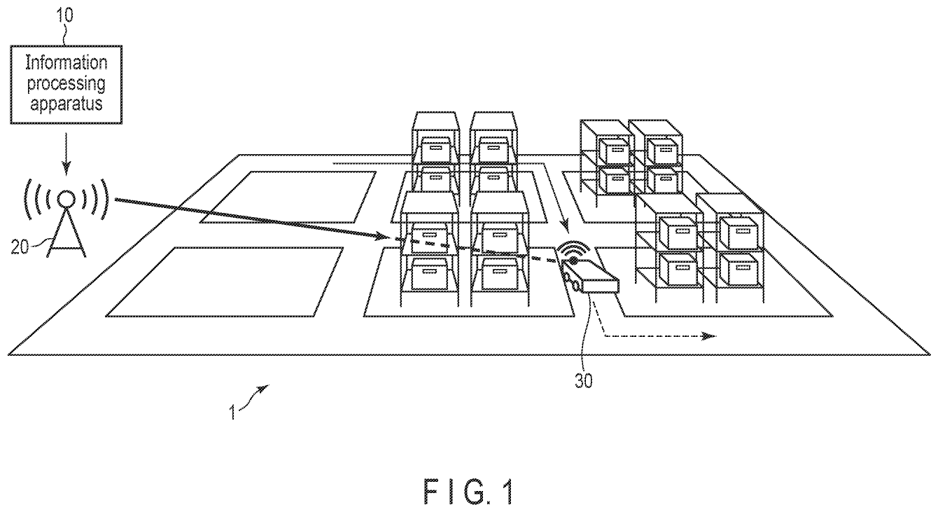

Here, an outline of a mobile robot system (mobile object system) according to the present embodiment will be described with reference to FIG. 1. As illustrated in FIG. 1, a mobile robot system 1 includes an information processing apparatus 10, a radio base station (access point) 20, and a mobile robot 30.

The information processing apparatus 10 includes, for example, an electronic device such as a multi-access edge computing (MEC) server or a cloud server on which a movement control function (travel control function) for the mobile robot 30 is mounted, and controls the mobile robot 30 in real time. In this case, the information processing apparatus 10 transmits a control signal regarding the movement of the mobile robot 30 to the mobile robot 30 via the radio base station 20.

The mobile robot 30 receives the control signal transmitted from the information processing apparatus 10 via the radio base station 20, and moves based on the control signal.

Note that, in the mobile robot system 1 illustrated in FIG. 1 described above, the mobile robot 30 is wirelessly controlled by using, for example, Wi-Fi (registered trademark), long term evolution (LTE), local 5G (private 5G), or the like, and thus, it is possible to provide a service for automatically conveying (carrying) a package to a destination (a determined position on a road).

Note that, although only one mobile robot 30 is illustrated in FIG. 1 for the sake of convenience, the mobile robot system 1 includes a plurality of mobile robots 30. The mobile robot system 1 in which the information processing apparatus 10 wirelessly controls the plurality of mobile robots 30 as described above is referred to as an integrated mobile robot system. Such a mobile robot system 1 (integrated mobile robot system) can be constructed at a lower cost than a system in which each of the plurality of mobile robots 30 autonomously operates by integrating functions of controlling the plurality of mobile robots 30 into one apparatus (information processing apparatus 10). In addition, since pieces of information on the plurality of mobile robots 30 moving in a target space can be collectively managed, the mobile robots 30 can be managed relatively easily.

Incidentally, in the mobile robot system 1 (integrated mobile robot system) described above, stabilized wireless communication is required in order to control the mobile robot 30 wirelessly. However, a wide variety of packages and devices are arranged in a target space such as the warehouse or factory described above, and the packages and devices may become obstacles that block radio waves (control signals). That is, there is a possibility that a radio wave environment for receiving the control signal changes from moment to moment in accordance with the movement of the mobile robot 30 and the arrangement of the obstacle, radio wave intensity of the control signal transmitted from the radio base station 20 (or antenna) is weakened in some places where the mobile robot 30 moves, and the control of the mobile robot 30 becomes unstable (that is, the mobile robot 30 does not normally receive the control signal).

In a case where the control of the mobile robot 30 is unstable as described above, there is a possibility that the mobile robot 30 performs an unintended operation and structures and persons around the mobile robot 30 are damaged. Specifically, for example, in a case where control signals are transmitted from the information processing apparatus 10 at regular intervals (predetermined intervals), when the mobile robot 30 cannot normally receive the control signals at the intervals, the mobile robot 30 continues to move based on, for example, a control signal received before the control signal, and the mobile robot 30 behaves unintentionally. In this case, for example, there is a possibility of collision with a surrounding structure or person, and the safety in the mobile robot system 1 deteriorates.

Thus, in the present embodiment, a mechanism for suppressing the deterioration in safety in the mobile robot system 1 is realized.

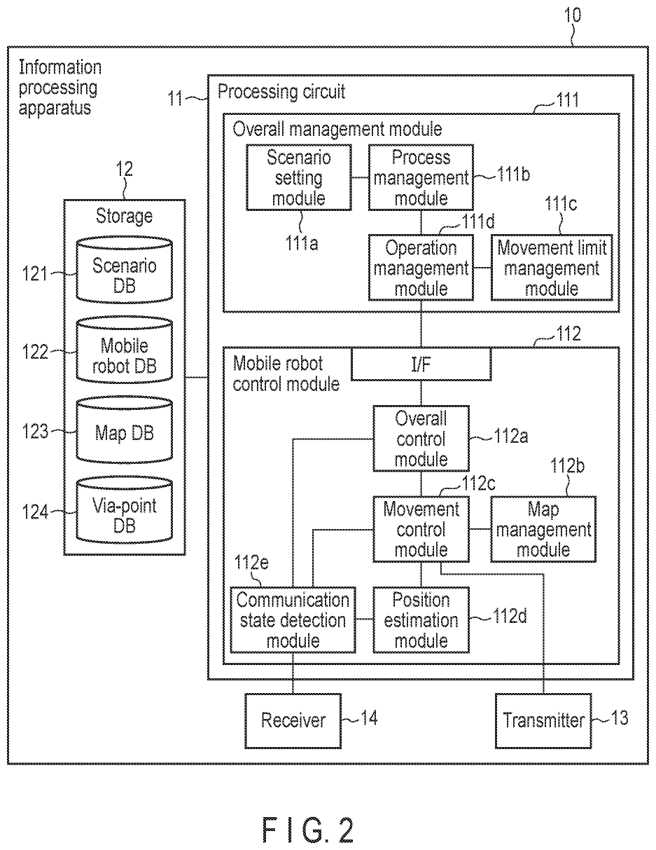

FIG. 2 illustrates an example of a functional configuration of the information processing apparatus 10 illustrated in FIG. 1. As illustrated in FIG. 2, the information processing apparatus 10 includes a processing circuit 11, a storage 12, a transmitter 13, and a receiver 14. The processing circuit 11 includes an overall management module 111 and a mobile robot control module 112.

The overall management module 111 is a functional module that manages the overall mobile robot system 1 (the plurality of mobile robots 30). The overall management module 111 includes a scenario setting module 111a, a process management module 111b, a movement limit management module 111c, and an operation management module 111d.

Here, the storage 12 includes a scenario DB 121 that stores a plurality of scenarios given from a higher-level system such as a warehouse management system (WMS) or a warehouse execution system (WES). Note that, in the scenario in the present embodiment, for example, a departure place and a destination of the mobile robot 30 provided in the mobile robot system 1, a service provided by the mobile robot 30, and the like (that is, a job performed by the mobile robot 30) are defined.

In addition, the storage 12 further includes, for example, a mobile robot DB 122 that stores mobile robot information indicating each of the plurality of mobile robots 30 moving in the target space. The mobile robot information includes, for example, a mobile robot ID for identifying the mobile robot 30, information regarding performance (specifications) of the mobile robot 30, and the like.

The scenario setting module 111a sets, for example, a scenario instructed by an administrator of the mobile robot system 1 (information processing apparatus 10) via a graphical user interface (GUI) or the like among the plurality of scenarios stored in the scenario DB 121 for the mobile robot 30 indicated by the mobile robot information stored in the mobile robot DB 122.

The process management module 111b manages a process of executing the scenario set by the scenario setting module 111a. The process management module 111b converts, for example, the scenario set for the mobile robot 30 into a list of commands for moving the mobile robot 30 according to the scenario. Note that, the list of commands converted from the scenario includes, for example, information on a point through which the mobile robot 30 passes when moving according to the scenario (hereinafter, referred to as via-point information). The process management module 111b notifies the operation management module 111d of the list of commands.

The movement limit management module 111c manages information regarding the limit on the movement of the mobile robot 30 in the target space (hereinafter, referred to as movement limit information). In the movement limit information, for example, a region where the mobile robot 30 cannot move (travel) in the target space, a limit value of a speed at which the mobile robot 30 moves, or the like is set.

The operation management module 111d instructs the mobile robot control module 112 of, for example, the list of commands notified from the process management module 111b and the movement limit information managed by the movement limit management module 111c based on, for example, the mobile robot information stored in the mobile robot DB 122, and manages the operation (movement) of the mobile robot 30 controlled by the mobile robot control module 112.

Note that, the overall management module 111 (the process management module 111b and the operation management module 111d) has a function of performing traffic regulation and the like as necessary while managing execution states of the scenarios in the plurality of mobile robots 30. Further, the overall management module 111 manages information (for example, a position of the mobile robot 30, a route along which the mobile robot 30 is moving, and various states of the mobile robot 30) and the like regarding each of the plurality of mobile robots 30.

The mobile robot control module 112 includes an overall control module 112a, a map management module 112b, a movement control module 112c, a position estimation module 112d, and a communication state detection module 112e. Note that, the mobile robot control module 112 is a functional module provided to correspond to each of the mobile robots 30, for example. That is, although not illustrated in FIG. 2, for example, in a case where the mobile robot system 1 includes the plurality of mobile robots 30 (that is, the plurality of mobile robots 30 move in the target space), the processing circuit 11 of the information processing apparatus 10 includes a plurality of mobile robot control modules 112.

The overall control module 112a is a functional module that controls the mobile robot control module 112 and the overall mobile robot 30 (hereinafter, referred to as a target mobile robot 30) corresponding to the mobile robot control module 112. The overall control module 112a receives an instruction (for example, the list of commands) from the operation management module 111d via an interface (I/F).

Here, the storage 12 includes a map DB 123 that stores map information indicating a map of the target space. In addition, the storage 12 includes a via-point DB 124 that stores a via-point (a point through which the mobile robot 30 passes) set in the target space and a coordinate value representing the via-point on the map of the target space in association with each other.

The overall control module 112a acquires a single command (for example, via-point information indicating a via-point to be moved next) to be executed next from the list of commands instructed from the operation management module 111d. The overall control module 112a refers to the via-point DB 124 to acquire the coordinate value of the via-point indicated by the acquired via-point information (that is, converts the via-point information into the coordinate value). The overall control module 112a outputs the acquired coordinate value of the via-point to the movement control module 112c.

The map management module 112b acquires the map information indicating the map of the target space where the target mobile robot 30 moves from the map DB 123, and manages the map information.

The movement control module 112c generates a route along which the target mobile robot 30 moves (a movement route to a next via-point) based on the coordinate value of the via-point output from the overall control module 112a, the map information managed by the map management module 112b, a current position of the target mobile robot 30 estimated by the position estimation module 112d to be described later, and information on obstacles present around the mobile robot 30 to be described later. The movement control module 112c generates a control signal regarding the movement of the target mobile robot 30 according to the generated route. Note that, the control signal generated by the movement control module 112c corresponds to, for example, a command (control message) regarding a moving direction and a speed of the target mobile robot 30.

The control signal generated by the movement control module 112c is transmitted by the transmitter 13 to the target mobile robot 30 via the radio base station 20. Note that, the transmitter 13 operates to transmit the control signals to the target mobile robot 30 at regular intervals.

Here, the target mobile robot 30 controlled based on the control signal transmitted from the transmitter 13 as described above operates to transmit data (sensor data) measured by a sensor provided in the target mobile robot 30 to the information processing apparatus 10 at regular intervals as a mobile robot state signal (mobile robot state message) regarding a state of the target mobile robot 30 and a peripheral state of the mobile robot 30. The mobile robot state signal transmitted from the target mobile robot 30 as described above is received by the receiver 14 via the radio base station 20.

The position estimation module 112d estimates the current position of the target mobile robot 30 based on the mobile robot state signal received by the receiver 14. Note that, the current position estimated by the position estimation module 112d is represented by the coordinate value on the map described above. The position estimation module 112d outputs the estimated current position of the target mobile robot 30 to the movement control module 112c. The current position of the target mobile robot 30 output from the position estimation module 112d as described above is used for generating the control signals regarding the route along which the target mobile robot 30 moves and the movement of the target mobile robot 30.

Note that, the route along which the target mobile robot 30 moves and the current position of the target mobile robot 30 estimated by the position estimation module 112d generated by the movement control module 112c are output from the mobile robot control module 112 to the overall management module 111 in order to manage the target mobile robot 30 in the overall management module 111, for example.

The communication state detection module 112e detects a communication state between the information processing apparatus 10 (radio base station 20) and the target mobile robot 30 based on whether or not the mobile robot state signal transmitted from the target mobile robot 30 is received by the receiver 14 as described above. In a case where the mobile robot state signal is received from the target mobile robot 30, the communication state detection module 112e detects that the communication state is normal (that is, normal state). On the other hand, in a case where the mobile robot state signal is not received from the target mobile robot 30, the communication state detection module 112e detects that the communication state is abnormal (that is, abnormal state).

The communication state (the normal state or the abnormal state) detected by the communication state detection module 112e is notified to the overall management module 111 via the overall control module 112a.

Note that, in a case where the communication state detection module 112e detects that the communication state is normal, the communication state detection module 112e outputs the mobile robot state signal received by the receiver 14 to the position estimation module 112d and the like. The mobile robot state signal output from the communication state detection module 112e to the position estimation module 112d as described above is used to estimate the current position of the target mobile robot 30. The mobile robot state signal output from the communication state detection module 112e to the movement control module 112c is used for generating the route and the control signal of the target mobile robot 30.

Here, for example, in a case where the communication state between the information processing apparatus 10 and the target mobile robot 30 is abnormal, when the other mobile robot 30 moves to the same position as the target mobile robot 30 (or in the vicinity of the target mobile robot 30), there is a high possibility that the other mobile robot 30 cannot receive the control signal and the control of the other mobile robot 30 becomes unstable.

Thus, when the communication state detection module 112e detects that the communication state is abnormal and the overall management module 111 is notified that the communication state is abnormal, the overall management module 111 (the process management module 111b and the operation management module 111d) specifies the route along which the target mobile robot 30 is moving based on the information regarding the target mobile robot 30 managed by the overall management module 111. The overall management module 111 specifies, for example, the other mobile robot 30 that is moving on the route or is scheduled to move along the route based on the specified route. The overall management module 111 instructs the mobile robot control module 112 corresponding to the other specified mobile robot 30 to generate the control signal (for example, a control signal for stopping the other mobile robot 30) regarding the movement of the other mobile robot 30.

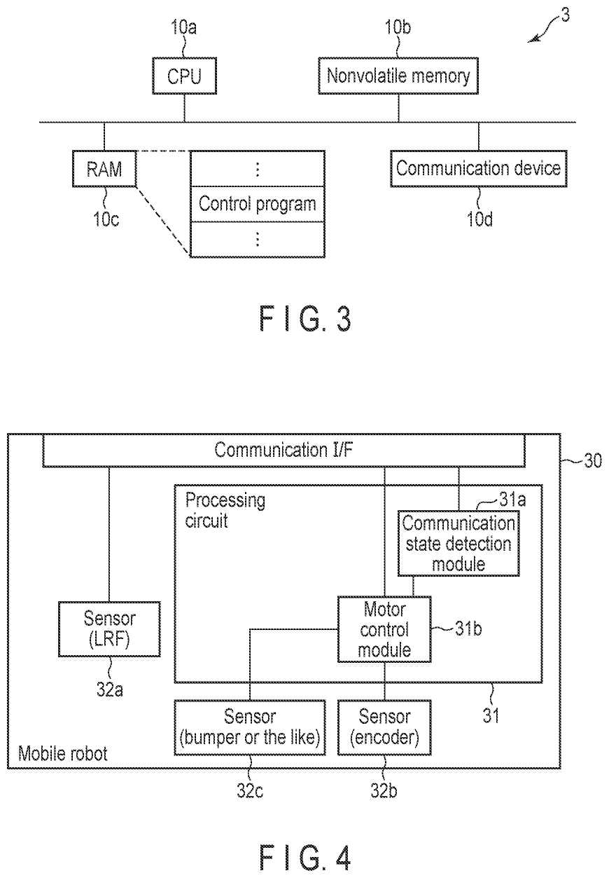

FIG. 3 illustrates an example of a system configuration of the information processing apparatus 10 illustrated in FIG. 2. The information processing apparatus 10 includes a CPU 10a, a nonvolatile memory 10b, a RAM 10c, a communication device 10d, and the like.

The CPU 10a is a processor for controlling operations of various components in the information processing apparatus 10. The CPU 10a may be a single processor or may include a plurality of processors. The CPU 10a executes various programs loaded from the nonvolatile memory 10b to the RAM 10c. The program executed by the CPU 10a includes a control program for controlling the plurality of mobile robots 30.

The nonvolatile memory 10b is a storage medium used as an auxiliary storage (memory) device. The RAM 10c is a storage medium used as a main storage (memory) device. Although only the nonvolatile memory 10b and the RAM 10c are illustrated in FIG. 3, the information processing apparatus 10 may include other storage devices such as a hard disk drive (HDD) and a solid state drive (SSD).

The communication device 10d is a device configured to execute wired communication or wireless communication. For example, it is assumed that the information processing apparatus 10 according to the present embodiment is connected to the radio base station 20 that executes wireless communication with each of the plurality of mobile robots 30 by wire (cable), but may be connected to the radio base station 20 via a network to execute wireless communication.

Note that, in the present embodiment, the processing circuit 11 illustrated in FIG. 2 is realized by at least one processor. The processor includes, for example, a control device and an arithmetic device, and is realized by an analog or digital circuit or the like. The processor may be the CPU 10a described above, or may be a general-purpose processor, a microprocessor, a digital signal processor (DSP), an ASIC, an FPGA, or a combination thereof.

In addition, the processing circuit 11 can be realized in a whole or part by causing the CPU 10a (that is, a computer of the information processing apparatus 10) to execute the above-described control program, that is, by software. This control program may be distributed in a state of being stored in a computer-readable storage medium, or may be downloaded to the information processing apparatus 10 via a network. Note that, the processing circuit 11 may be realized in a whole or part by dedicated hardware or the like.

In addition, in the present embodiment, the storage 12 illustrated in FIG. 2 is realized by, for example, the nonvolatile memory 10b or another storage device. Further, in the present embodiment, the transmitter 13 and the receiver 14 illustrated in FIG. 2 are realized by, for example, the communication device 10d.

Note that, in the present embodiment, it is assumed that the information processing apparatus 10 is realized by one apparatus, but the information processing apparatus 10 may be realized by a plurality of apparatuses. Specifically, the information processing apparatus 10 may be realized by, for example, a first apparatus including the overall management module 111 and a second apparatus including the plurality of mobile robot control modules 112. Further, the information processing apparatus 10 may be realized by, for example, a first apparatus including the overall management module 111, and a plurality of second apparatuses including the plurality of mobile robot control modules 112, respectively.

FIG. 4 illustrates an example of a functional configuration of the mobile robot 30 illustrated in FIG. 1. As illustrated in FIG. 4, the mobile robot 30 includes a processing circuit 31.

The processing circuit 31 controls the movement (operation) of the mobile robot 30 by processing a control signal (a command regarding a moving direction, a speed, and the like) transmitted from the information processing apparatus 10 (mobile robot control module 112). The processing circuit 31 includes a communication state detection module 31a and a motor control module 31b.

The control signals transmitted from the information processing apparatus 10 at regular intervals as described above are received by a communication interface (I/F). The communication state detection module 31a detects the communication state between the information processing apparatus 10 (radio base station 20) and the mobile robot 30 based on whether or not the control signal transmitted from the information processing apparatus 10 is received by the communication interface. In a case where the control signal is received from the information processing apparatus 10, the communication state detection module 31a detects that the communication state is normal (that is, normal state). On the other hand, in a case where the control signal is not received from the information processing apparatus 10, the communication state detection module 31a detects that the communication state is abnormal (that is, abnormal state).

In a case where the communication state detection module 31a detects that the communication state is normal, the communication state detection module 31a outputs the received control signal (the command regarding the moving direction, speed, and the like) to the motor control module 31b. On the other hand, in a case where the communication state detection module 31a detects that the communication state is abnormal, the communication state detection module 31a outputs the control signal for stopping (the movement of) the mobile robot 30 to the motor control module 31b.

The motor control module 31b controls a motor (actuator) mounted on the mobile robot 30 based on the control signal output from the communication state detection module 31a.

Further, various sensors are provided in the mobile robot 30. In the example illustrated in FIG. 4, first to third sensors 32a to 32c are illustrated.

The first sensor 32a includes, for example, a laser range finder (LRF). According to the first sensor 32a, a distance from the mobile robot 30 to a wall or an obstacle present around the mobile robot 30 is measured based on a time until a laser (light) emitted from the first sensor 32a is reflected.

The second sensor 32b includes, for example, a sensor (encoder) provided in the motor. According to the second sensor 32b, a rotational speed, a rotation angle, a rotational speed, and the like of the motor can be measured. Sensor data (encoder value) indicating the rotational speed and the like measured by the second sensor 32b is transmitted to the motor control module 31b, and an actual movement direction and movement speed of the mobile robot 30 are calculated from the sensor data.

The sensor data indicating the distance measured by the first sensor 32a, the sensor data (encoder value) indicating the rotational speed of the motor measured by the second sensor 32b, and the actual movement speed of the mobile robot 30 calculated by the motor control module 31b are transmitted as the mobile robot state signals to the information processing apparatus 10 via the communication interface at regular intervals, and are used for estimating the current position of the mobile robot 30.

The third sensor 32c is installed, for example, on a bumper or the like provided in a housing of the mobile robot 30. According to the third sensor 32c, it is possible to detect that an object comes into contact with the bumper. A detection result by the third sensor 32c (sensor data indicating that the object comes into contact with the bumper) is output to, for example, the motor control module 31b. Accordingly, the motor control module 31b can realize a safety function of stopping the mobile robot 30 when the object comes into contact with the bumper. Note that, the sensor data indicating the contact of the object with the bumper detected by the third sensor 32c may be transmitted to the information processing apparatus 10, as the mobile robot state signal together with the sensor data indicating the distance measured by the first sensor 32a, the sensor data indicating the rotational speed of the motor measured by the second sensor 32b, and the actual movement speed of the mobile robot 30.

Here, it has been described that the first to third sensors 32a to 32b are provided in the mobile robot 30, but another sensor such as a camera may be provided in the mobile robot 30.

Note that, although not illustrated, the processing circuit 31 illustrated in FIG. 4 is realized by at least one processor. The processor includes, for example, a control device and an arithmetic device, and is realized by an analog or digital circuit or the like. The processor may be, for example, a CPU, or may be a general-purpose processor, a microprocessor, a digital signal processor (DSP), an ASIC, an FPGA, or a combination thereof.

In addition, the processing circuit 31 can be realized in a whole or part by causing the CPU (that is, a computer of the mobile robot 30) included in the mobile robot 30 to execute a predetermined program, that is, by software. This program may be distributed in a state of being stored in a computer-readable storage medium, or may be downloaded to the mobile robot 30 via a network. Note that, the processing circuit 31 may be realized in a whole or part by dedicated hardware or the like.

Note that, although only the functional configuration of one mobile robot 30 is illustrated in FIG. 4, the same applies to the functional configurations of the other mobile robots 30.

Here, the mobile robot system 1 according to the present embodiment is configured to detect a communication state (state of wireless connection) on both the information processing apparatus 10 (MEC server) side and the mobile robot 30 side. Hereinafter, the communication state detection module 112e on the information processing apparatus 10 side and the communication state detection module 31a on the mobile robot 30 side will be described in detail.

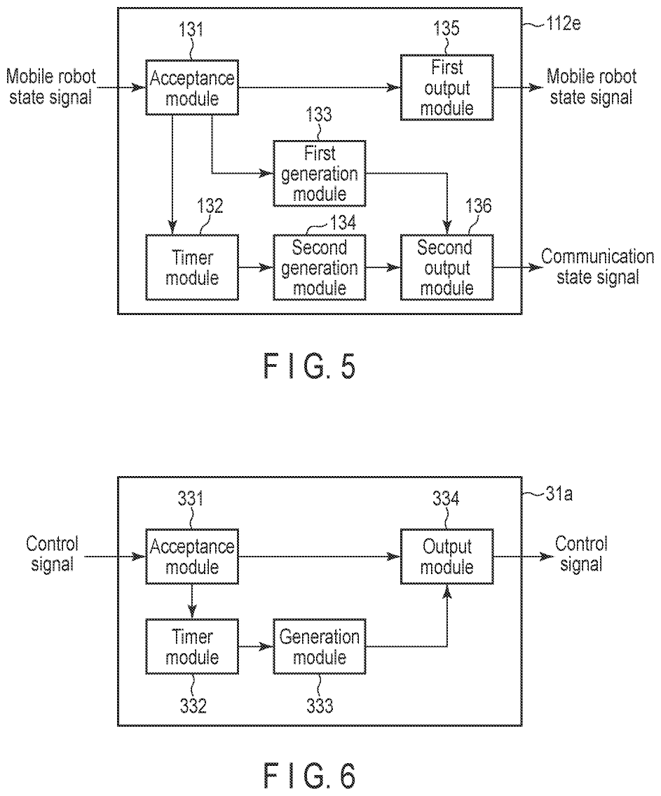

First, FIG. 5 illustrates an example of a configuration of the communication state detection module 112e on the information processing apparatus 10 side. As illustrated in FIG. 5, the communication state detection module 112e includes an acceptance module 131, a timer module 132, a first generation module 133, a second generation module 134, a first output module 135, and a second output module 136.

In a case where the mobile robot state signal (sensor data) transmitted from the mobile robot 30 is received by the receiver 14, the acceptance module 131 receives the mobile robot state signal. Accordingly, the communication state detection module 112e detects that the communication state between the information processing apparatus 10 and the mobile robot 30 is normal. In this case, the acceptance module 131 outputs a reset signal based on the detection that the communication state is normal to the timer module 132, outputs a trigger signal for giving an instruction about the generation of the communication state signal to the first generation module 133, and outputs the received mobile robot state signal to the first output module 135.

The timer module 132 includes a timer that measures a predetermined time. Note that, the time measured by the timer is set to be at least a time longer than a regular interval at which the mobile robot state signal is transmitted from the mobile robot 30 described above (that is, longer than a transmission cycle of the mobile robot state signal). In a case where the reset signal is output from the acceptance module 131, the timer module 132 resets the time measurement by the timer based on the reset signal. On the other hand, in a case where the predetermined time has been measured by the timer (that is, the predetermined time has elapsed and the timeout has occurred), the communication state detection module 112e detects that the communication state between the information processing apparatus 10 and the mobile robot 30 is abnormal. In this case, the timer module 132 outputs the trigger signal for giving the instruction about the generation of the communication state signal to the second generation module 134.

The first generation module 133 generates a first communication state signal based on the trigger signal output from the acceptance module 131. Note that, the first communication state signal is a signal indicating that the communication state between the information processing apparatus 10 and the mobile robot 30 is normal (that is, normal state). The first generation module 133 outputs the generated first communication state signal to the second output module 136.

The second generation module 134 generates a second communication state signal based on the trigger signal output from timer module 132. Note that, the second communication state signal is a signal indicating that the communication state between the information processing apparatus 10 and the mobile robot 30 is abnormal (that is, abnormal state). The second generation module 134 outputs the generated second communication state signal to the second output module 136.

The first output module 135 outputs the mobile robot state signal output from the acceptance module 131 to, for example, the position estimation module 112d.

In a case where the first communication state signal is output from the first generation module 133, the second output module 136 outputs the first communication state signal to the overall control module 112a. In addition, in a case where the second communication state signal is output from the second generation module 134, the second output module 136 outputs (notifies) the second communication state signal to the overall control module 112a.

Note that, here, it is assumed that the first communication state signal is generated whenever the trigger signal is output from the acceptance module 131 to the first generation module 133, but the first communication state signal may be generated, for example, in a case where a predetermined number of trigger signals are output. In other words, the first communication state signal may be generated by thinning.

Next, FIG. 6 illustrates an example of a configuration of the communication state detection module 31a on the mobile robot 30 side. As illustrated in FIG. 6, the communication state detection module 31a includes an acceptance module 331, a timer module 332, a generation module 333, and an output module 334.

In a case where a control signal (a command regarding the moving direction, the speed, and the like) transmitted from the information processing apparatus 10 is received by the communication interface of the mobile robot 30, the acceptance module 331 receives the control signal. Accordingly, the communication state detection module 31a detects that the communication state between the information processing apparatus 10 and the mobile robot 30 is normal. In this case, the acceptance module 331 outputs the reset signal based on the detection that the communication state is normal to the timer module 332, and outputs the received control signal to the output module 334. Note that, in the following description, the control signal received by the acceptance module 331 is referred to as a first control signal.

The timer module 332 includes a timer that measures a predetermined time. Note that, the time measured by the timer is set to be a time longer than at least a regular interval at which the control signal is transmitted from the information processing apparatus 10 described above (that is, longer than a transmission cycle of the control signal). In a case where the reset signal is output from the acceptance module 131, the timer module 332 resets time measurement by the timer based on the reset signal. On the other hand, in a case where the predetermined time has been measured by the timer (the predetermined time has elapsed and the timeout has occurred), the communication state detection module 31a detects that the communication state between the information processing apparatus 10 and the mobile robot 30 is abnormal. In this case, the timer module 332 outputs a trigger signal for giving an instruction about the generation of the control signal to the generation module 333.

The generation module 333 generates a second control signal based on the trigger signal output from the timer module 132. The second control signal is a signal for stopping (the movement of) the mobile robot 30, and corresponds to, for example, a command to set the speed to 0. The generation module 333 outputs the generated second control signal to the output module 334.

In a case where the first control signal is output from the acceptance module 331, the output module 334 outputs the first control signal to the motor control module 31b. Accordingly, the mobile robot 30 is controlled to move based on the first control signal. In addition, in a case where the second control signal is output from the generation module 333, the output module 334 outputs the second control signal to the motor control module 31b. Accordingly, the mobile robot 30 is controlled to stop based on the second control signal.

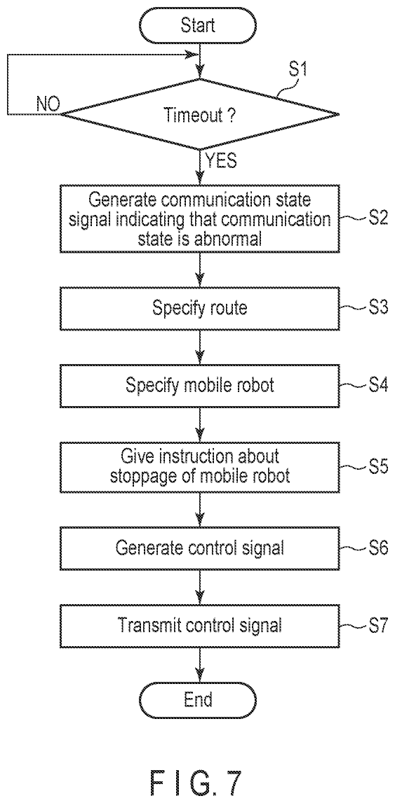

Hereinafter, an operation of the mobile robot system 1 according to the present embodiment will be described. First, an example of a processing procedure of the information processing apparatus 10 will be described with reference to a flowchart of FIG. 7.

Here, it is assumed that the plurality of mobile robots 30 including the first mobile robot 30 is moving in the target space. Note that, each of the plurality of mobile robots 30 is controlled to move based on the control signals transmitted at regular intervals from the mobile robot control module 112 corresponding to the mobile robot 30 described above (one of the plurality of mobile robot control modules 112 included in the processing circuit 11 of the information processing apparatus 10). In the following description, the mobile robot control module 112 corresponding to the first mobile robot 30 included in the plurality of mobile robots 30 is referred to as a first mobile robot control module 112.

Here, the first mobile robot 30 controlled based on the control signals transmitted from the first mobile robot control module 112 at regular intervals as described above transmits the mobile robot state signal (sensor data) regarding the state of the first mobile robot 30 to the information processing apparatus 10 (first mobile robot control module 112) at regular intervals. Note that, the interval at which the control signal is transmitted from the first mobile robot control module 112 and the interval at which the mobile robot state signal is transmitted from the first mobile robot 30 may be the same or different.

In a case where the mobile robot state signals transmitted from the first mobile robot 30 at regular intervals are normally received by the receiver 14 as described above, the first mobile robot control module 112 generates the control signals at regular intervals to move along the route generated based on the current position of the first mobile robot 30 estimated based on the mobile robot state signal, for example. The control signal generated as described above is transmitted to the first mobile robot 30 by the transmitter 13.

Note that, in FIG. 7, processing in a case where the mobile robot state signal transmitted from the first mobile robot 30 is normally received is omitted, and processing in a case where the mobile robot state signal is not received is illustrated.

In a case where the receiver 14 does not receive the mobile robot state signal as described above, the acceptance module 131 does not output the reset signal to the timer module 132. Thus, the communication state detection module 112e determines whether or not the predetermined time has been measured by the timer included in the timer module 132 (that is, the timeout has occurred) (step S1).

Note that, “timeout” in step S1 means that an abnormality has occurred in the communication state between the information processing apparatus 10 and the first mobile robot 30 to such an extent that the mobile robot state signals transmitted from the first mobile robot 30 at regular intervals cannot be normally received (wireless communication is disconnected or a delayed from a predetermined time occurs).

In a case where it is determined that the timeout has not occurred (NO in step S1), the processing returns to step S1 and is repeated.

On the other hand, in a case where it is determined that the timeout has occurred (YES in step S1), the trigger signal is output from the timer module 132 to the second generation module 134. In this case, the second generation module 134 generates the communication state signal (second communication state signal) indicating that the communication state between the information processing apparatus 10 and the first mobile robot 30 is abnormal based on the trigger signal output from the timer module 132 (step S2).

When the processing in step S2 is executed, the second output module 136 outputs the second communication state signal generated in step S2. The second communication state signal output from the second output module 136 as described above is notified to the overall management module 111 via the overall control module 112a. Note that, in a case where the second communication state signal is generated by the second generation module 134 (the second communication state signal is output from the second output module 136), the measurement of the time by the timer included in the timer module 132 is reset, and the measurement of the time is started again.

The overall management module 111 (the process management module 111b and the operation management module 111d) can grasp that the communication state between the information processing apparatus 10 and the first mobile robot 30 is abnormal based on the second communication state signal notified from the first mobile robot control module 112. In this case, the overall management module 111 specifies the route along which the first mobile robot 30 is moving based on the information regarding the first mobile robot 30 managed by the overall management module 111 (step S3).

Subsequently, the overall management module 111 specifies the second mobile robot 30 based on the route specified in step S3 (step S4). Note that, the second mobile robot 30 specified in step S4 is, for example, the mobile robot 30 other than the first mobile robot 30 among the plurality of mobile robots 30 moving in the target space, and is the mobile robot 30 moving along the route specified in step S3.

In a case where the processing in step S4 is executed, the overall management module 111 instructs the mobile robot control module 112 (hereinafter, referred to as a second mobile robot control module 112) corresponding to the second mobile robot 30 specified in step S4 to stop the second mobile robot 30 (step S5). Note that, the overall management module 111 retains information indicating the second mobile robot 30 that has been instructed to stop by the execution of the processing in step S5 (that is, manages the mobile robot 30 being stopped).

Subsequently, the second mobile robot control module 112 (the overall control module 112a and the movement control module 112c) generates the control signal based on the instruction from the overall management module 111 in step S5 (step S6). The control signal generated by the second mobile robot control module 112 in this case corresponds to, for example, the command to set the speed of the second mobile robot 30 to 0 (that is, to stop the second mobile robot 30).

The control signal generated in step S6 is transmitted to the second mobile robot 30 by the transmitter 13 (step S7).

Note that, it is considered that the second mobile robot 30 receives the control signal for moving along the route generated for the second mobile robot 30 and moves based on the control signal. However, in a case where the processing in step S7 is executed, the control signal transmitted in step S7 is given priority, and the second mobile robot 30 stops based on the control signal transmitted in step S7.

Note that, in a case where the other mobile robot 30 moves to the vicinity of the first mobile robot 30 in which the communication state with the information processing apparatus 10 is abnormal as described above, it is considered that the communication state between the information processing apparatus 10 and the other mobile robot 30 becomes abnormal and the control of the other mobile robot 30 is unstable.

However, in the present embodiment, in a case where the mobile robot state signal transmitted from the first mobile robot 30 is not received, the second mobile robot 30 can be stopped in advance before the second mobile robot 30 moves to the vicinity of the first mobile robot 30 (that is, the control becomes unstable) by executing the processing illustrated in FIG. 7 described above.

Incidentally, in the present embodiment, from the viewpoint of preventing the communication state between the information processing apparatus 10 and the other mobile robot 30 from becoming abnormal in a case where the other mobile robot 30 moves to the vicinity of the first mobile robot 30, for example, it is considered that the other mobile robot 30 moving along the same route as the first mobile robot 30 is specified as the second mobile robot 30 in step S4 illustrated in FIG. 7 described above. Note that, in the present embodiment, the mobile robot “moving along the same route” means that a via-point at a start point of the route coincides with a via-point at an end point of the route and the mobile robot is moving along a route passing through at least the vicinity of the first mobile robot 30.

However, the second mobile robot 30 specified in step S4 is not limited to the mobile robot 30 moving along the same route as the first mobile robot 30. Specifically, the second mobile robot 30 may be, for example, the mobile robot 30 that is not moving along the same route as the first mobile robot 30 but is scheduled to move along the route. In addition, for example, the second mobile robot 30 may be the mobile robot 30 that is not moving along the same route as the first mobile robot 30 or is not scheduled to move along the same route, but is moving along another route moving (passing) through the vicinity the first mobile robot 30 or is scheduled to move along the other route.

That is, in the present embodiment, it is considered that the communication state around the first mobile robot 30 is abnormal, the mobile robot 30 that needs to be stopped in order to avoid the communication state from becoming abnormal may be specified as the second mobile robot.

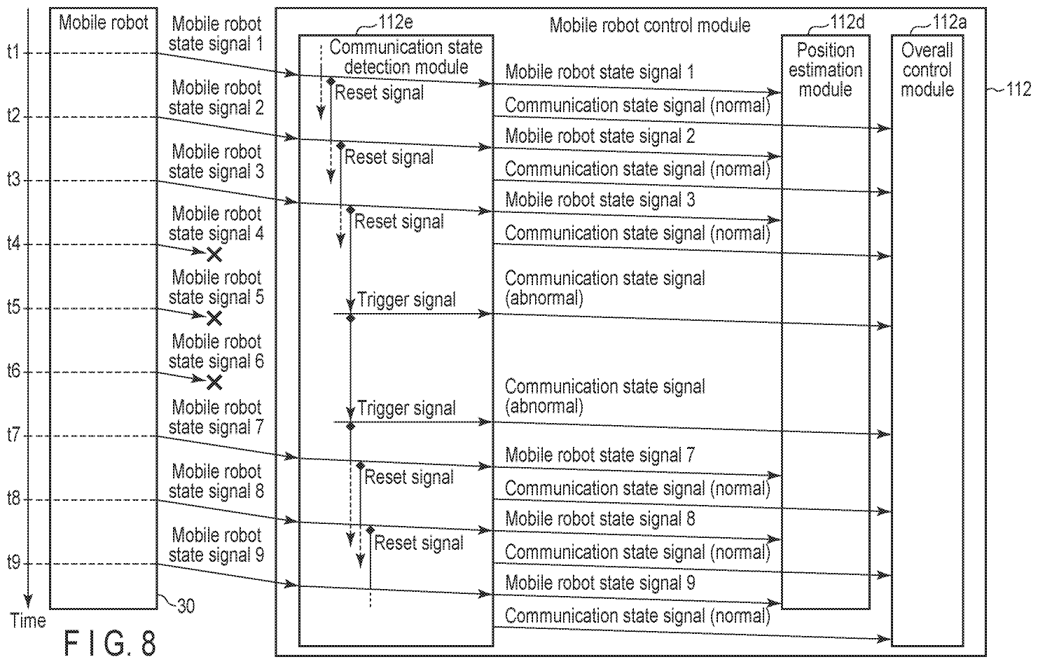

Here, an operation of the communication state detection module 112e on the information processing apparatus 10 side will be specifically described with reference to FIG. 8.

In the example illustrated in FIG. 8, it is assumed that the mobile robot 30 transmits the mobile robot state signals at each of times t1 to t9 (that is, at regular intervals).

First, it is assumed that a mobile robot state signal 1 is transmitted from the mobile robot 30 to the mobile robot control module 112 (information processing apparatus 10) corresponding to the mobile robot 30 at time t1.

When the mobile robot state signal 1 transmitted as described above is received by the receiver 14, the measurement of the time by the timer included in the timer module 132 is reset based on the reset signal output from the acceptance module 131 included in the communication state detection module 112e. In this case, the trigger signal is not output from the timer module 132.

In addition, in a case where the receiver 14 receives the mobile robot state signal 1, the acceptance module 131 outputs the mobile robot state signal 1 to the first output module 135, and the first output module 135 outputs the mobile robot state signal 1 to the position estimation module 112d. Further, in a case where the mobile robot state signal 1 is received by the receiver 14, the trigger signal is output from the acceptance module 131 to the first generation module 133, and thus, the first generation module 133 generates the first communication state signal indicating that the communication state is normal. Accordingly, the second output module 136 outputs the first communication state signal to the overall control module 112a.

Although time t1 has been described here, FIG. 8 illustrates that the communication state detection module 112e operates similarly at times t2 and t3.

Here, it is assumed that the mobile robot 30 moves to a position where an obstacle (radio wave shield) is to be arranged between the radio base station 20 and the mobile robot 30, and thus, for example, immediately after time t3, an abnormality has occurred in the communication state between the information processing apparatus 10 and the mobile robot 30 (wireless communication is disconnected).

In this case, at time t4, a mobile robot state signal 4 is transmitted from the mobile robot 30 to the mobile robot control module 112 (information processing apparatus 10) corresponding to the mobile robot 30, but the mobile robot state signal 4 is not received by the receiver 14.

In a case where the mobile robot state signal 4 is not received by the receiver 14 as described above, since the reset signal is not output from the acceptance module 131 included in the communication state detection module 112e, the measurement of the time by the timer included in the timer module 132 is not reset. Accordingly, when the predetermined time has been measured by the timer (that is, the timeout has occurred), the trigger signal is output from the timer module 132 to the second generation module 134.

In this case, the second generation module 134 generates the second communication state signal indicating that the communication state is abnormal, and the second output module 136 outputs the second communication state signal to the overall control module 112a.

Note that, in a case where the second communication state signal is output from the communication state detection module 112e (second output module 136), the measurement of the time by the timer included in the timer module 132 is reset.

In FIG. 8, for example, it is assumed that the communication state is abnormal in a time zone from immediately after time t3 to immediately before time t7. In this time zone, the communication state detection module 112e operates to output the second communication state signal to the overall control module 112a whenever the timeout has occurred.

Here, for example, it is assumed that the abnormality of the communication state is eliminated immediately before time t7 due to removal of the obstacle (radio wave shield) arranged between the radio base station 20 and the mobile robot 30. In this case, a mobile robot state signal 7 transmitted from the mobile robot 30 at time t7 is received by the receiver 14. Accordingly, the communication state detection module 112e operates to output the mobile robot state signal 7 to the position estimation module 112d and output the first communication state signal to the overall control module 112a, similarly to time t1 described above. The same applies to times t8 and t9.

In FIG. 8, in a case where the mobile robot state signal transmitted from the mobile robot 30 cannot reach the information processing apparatus 10 due to the occurrence of the abnormality in the communication state in the time zone including time t4 to t6 (the disconnection of the wireless communication), since the second communication state signal indicating that the communication state is abnormal due to the timeout in the timer is output to the overall control module 112a, the overall control module 112a can immediately recognize the abnormality of the communication state.

Note that, in the present embodiment, due to the use of the timer, for example, it is less likely to be influenced by a processing time due to an arithmetic load of the CPU 10a or the like, and it is possible to recognize the abnormality of the communication state in a short time.

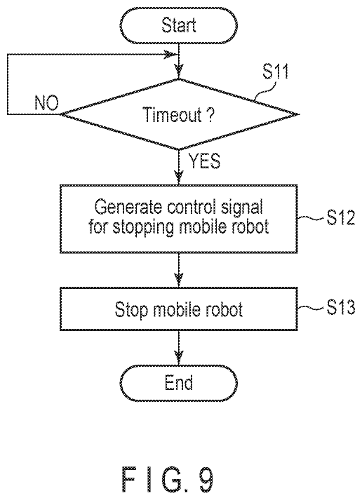

Next, an example of a processing procedure of the mobile robot 30 will be described with reference to a flowchart of FIG. 9.

In the present embodiment, in a case where the control signal is transmitted from the mobile robot control module 112 corresponding to the mobile robot 30 (one of the plurality of mobile robot control modules 112 included in the processing circuit 11 of the information processing apparatus 10) to the mobile robot 30 at regular intervals and the control signal is normally received as described above, the mobile robot 30 is controlled to move based on the control signal.

Note that, in FIG. 9, processing in a case where the control signal transmitted from the mobile robot control module 112 is normally received is omitted, and processing in a case where the control signal is not received is illustrated.

In a case where the control signal is not received by the communication interface of the mobile robot 30 as described above, the acceptance module 331 does not output the reset signal to the timer module 332. Thus, the communication state detection module 112e determines whether or not the predetermined time has been measured by the timer included in the timer module 332 (that is, the timeout has occurred) (step S11).

Note that, “timeout” in step S11 means that an abnormality has occurred in the communication state between the information processing apparatus 10 and the mobile robot 30 to such an extent that the control signals transmitted from the mobile robot control module 112 (information processing apparatus 10) at regular intervals cannot be normally received (wireless communication is disconnected or a delayed from a predetermined time occurs).

In a case where it is determined that the timeout has not occurred (NO in step S11), the processing returns to step S11 and is repeated.

On the other hand, in a case where it is determined that the timeout has occurred (YES in step S11), the trigger signal is output from the timer module 332 to the generation module 333. In this case, the generation module 333 generates the control signal (second control signal) for stopping the mobile robot 30 based on the trigger signal output from the timer module 332 (step S12).

In a case where the processing in step S12 is executed, the output module 334 outputs the second control signal generated in step S12 to the motor control module 31b. Note that, in a case where the second control signal is generated by the generation module 333 (the second control signal is output by the output module 334), the measurement of the time by the timer included in the timer module 332 is reset, and the measurement of the time is started again.

The motor control module 31b controls the motor mounted on the mobile robot 30 based on the second control signal output from the communication state detection module 31a (output module 334), and stops the mobile robot 30 (step S13).

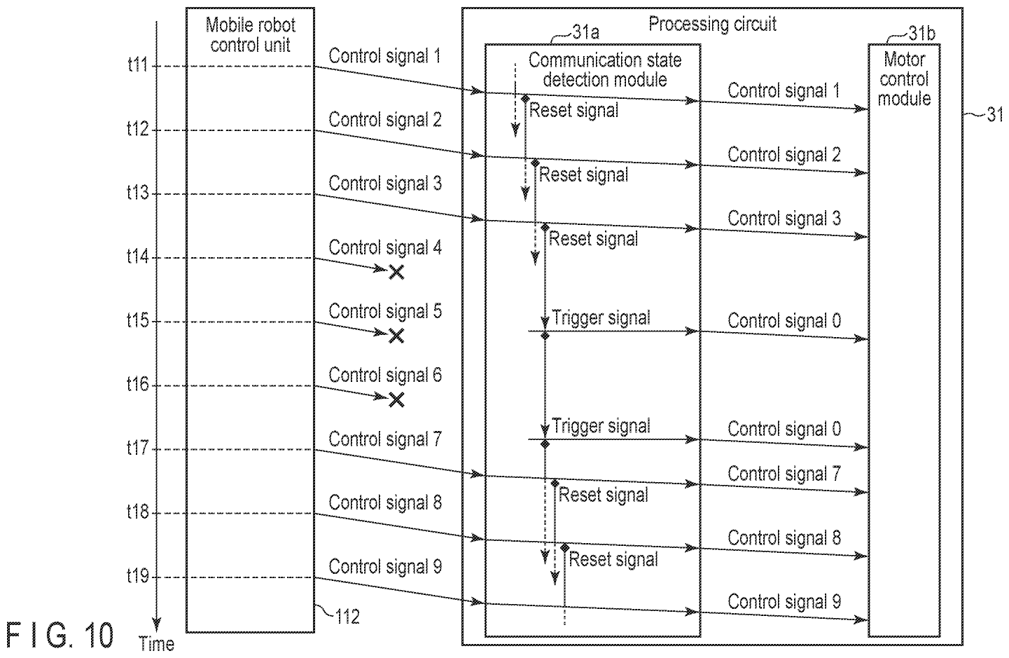

Here, an operation of the communication state detection module 31a on the mobile robot 30 side will be specifically described with reference to FIG. 10.

In the example illustrated in FIG. 10, it is assumed that the mobile robot control module 112 corresponding to the mobile robot 30 transmits the control signals at each of times t1l to t19 (that is, at regular intervals).

First, it is assumed that a control signal 1 is transmitted from the mobile robot control module 112 to the mobile robot 30 corresponding to the mobile robot control module 112 at time t1l.

When the control signal 1 transmitted as described above is received by the communication interface of the mobile robot 30, the measurement by the timer included in the timer module 332 is reset based on the reset signal output from the acceptance module 331 included in the communication state detection module 31a. In this case, the trigger signal is not output from the timer module 332.

In addition, in a case where the control signal 1 is received by the communication interface of the mobile robot 30, the acceptance module 331 outputs the control signal 1 to the output module 334, and the output module 334 outputs the control signal 1 to the motor control module 31b.

Although time t1l has been described here, FIG. 10 illustrates that the communication state detection module 31a operates similarly at times t12 and t13.

Here, it is assumed that the mobile robot 30 moves to a position where an obstacle (radio wave shield) is to be arranged between the radio base station 20 and the mobile robot 30, and thus, for example, an abnormality has occurred in the communication state between the information processing apparatus 10 and the mobile robot 30 (wireless communication is disconnected) immediately after time t13.

In this case, although a control signal 4 is transmitted from the mobile robot control module 112 to the mobile robot 30 at time t14, the control signal 4 is not received by the communication interface of the mobile robot 30.

In a case where the control signal 4 is not received by the communication interface as described above, since the reset signal is not output from the acceptance module 331, the measurement of the time by the timer included in the timer module 332 is not reset. Accordingly, in a case where the predetermined time has been measured by the timer (that is, the timeout has occurred), the trigger signal is output from the timer module 332 to the generation module 333.

In this case, the generation module 333 generates a control signal 0 for stopping the mobile robot 30, and the output module 334 outputs the control signal 0 to the motor control module 31b.

Note that, in a case where the control signal 0 is output from the communication state detection module 31a (output module 334), the measurement by the timer included in the timer module 332 is reset.

In FIG. 10, for example, it is assumed that the communication state is abnormal in the time zone from immediately after time t13 to immediately before time t17. In this time zone, the communication state detection module 31a operates to output the control signal 0 to the motor control module 31b whenever the timeout has occurred.

Here, for example, it is assumed that the abnormality of the communication state is eliminated immediately before time t17 by removal of the obstacle (radio wave shield) arranged between the radio base station 20 and the mobile robot 30. In this case, a control signal 7 transmitted from the mobile robot control module 112 at time t17 is received by the communication interface of the mobile robot 30. Accordingly, the communication state detection module 31a operates to output control signal 7 to the motor control module 31b similarly to time t1l described above. The same applies to times t18 and t19.

In FIG. 10, in a case where the control signal transmitted from the mobile robot control module 112 cannot reach the mobile robot 30 due to the occurrence of the abnormality in the communication state in the time zone including time t14 to time t16 (the disconnection of the wireless communication), since the control signal for stopping the mobile robot 30 due to the timeout in the timer is output to the motor control module 31b, the mobile robot 30 can be safely stopped.

Note that, in the present embodiment, due to the use of the timer, for example, it is less likely to be influenced by a processing time due to an arithmetic load of the CPU or the like, and it is possible to recognize the abnormality of the wireless state in a short time.

Incidentally, in the present embodiment, for example, in a case where the communication state detection module 112e on the information processing apparatus 10 side detects that the communication state is abnormal, it is considered that there is a high possibility that the communication state detection module 31a on the mobile robot 30 side also detects that the communication state is abnormal. However, even in a case where one communication state detection module detects that the communication state is abnormal in some communication states (radio wave environment) between the information processing apparatus 10 and the mobile robot 30, there is a possibility that the other communication state detection module detects that the communication state is normal. However, in the present embodiment, the communication state detection module 112e on the information processing apparatus 10 side and the communication state detection module 31a on the mobile robot 30 side may operate independently of each other, and the communication state detected by the communication state detection module 112e (that is, the detection result by the communication state detection module 112e) and the communication state detected by the communication state detection module 31a (that is, the detection result by the communication state detection module 31a) may be different.

For example, in a case where the mobile robot state signal transmitted from the first mobile robot 30 (first mobile object) at regular intervals is not received as described above, the information processing apparatus 10 according to the present embodiment specifies a route along which the first mobile robot 30 moves, specifies the second mobile robot 30 (second mobile object) different from the first mobile robot 30 based on the specified route, and generates the control signal (second control signal) regarding the movement of the specified second mobile robot 30.

Note that, the second control signal generated as described above is, for example, a signal for stopping the second mobile robot, and the second mobile robot 30 specified in a case where the mobile robot state signal is not received from the first mobile robot 30 is, for example, the mobile robot 30 moving along the route along which the first mobile robot 30 is moving or scheduled to move along the route.

Further, the processing circuit 31 included in the mobile robot 30 according to the present embodiment controls the mobile robot 30 based on the control signal (first control signal) transmitted from the information processing apparatus 10 (mobile robot control module 112) in a case where the control signal is received by the communication interface of the mobile robot 30, and controls the mobile robot 30 based on the control signal (third control signal) for stopping the mobile robot 30 in a case where the control signal is not received by the communication interface of the mobile robot 30.

In the present embodiment, with the above-described configuration, the safety in the mobile robot system 1 (that is, an environment in which the mobile robot 30 moves in the target space) can be improved.

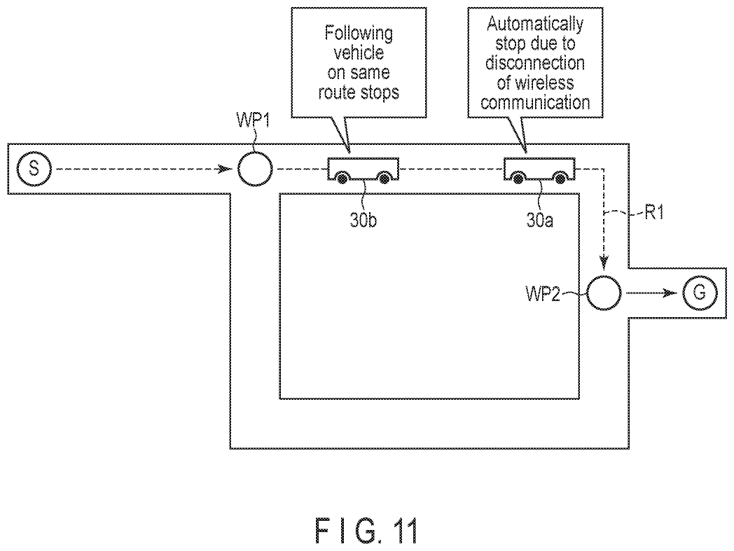

Here, the safety in the mobile robot system 1 according to the present embodiment will be briefly described with reference to FIG. 11. In FIG. 11, it is assumed that a mobile robot 30a is moving along a route R1 from a via-point WP1 to a via-point WP2 between a departure point S and a destination G.

In a case where the information processing apparatus 10 (the receiver 14) does not receive the mobile robot state signals transmitted at regular intervals from the mobile robot 30a moving along the route R1 as described above, a mobile robot 30b (a following vehicle along the same route as the mobile robot 30a) moving along the same route R1 as the mobile robot 30a can be stopped in the present embodiment.

Accordingly, it is possible to prevent the communication state of the mobile robot 30b from becoming abnormal (that is, the control becomes unstable), for example, in the vicinity of the mobile robot 30a by the mobile robot 30b moving along the same route as the mobile robot 30a in which the communication state is abnormal (that is, the control signal cannot be received).

In addition, in a case where the mobile robot 30a does not receive the control signals transmitted from the information processing apparatus 10 at regular intervals, the mobile robot 30a can be stopped (that is, the wireless communication is automatically stopped by being disconnected) in the present embodiment.

Accordingly, it is possible to avoid a situation where the mobile robot 30a of which the communication state is abnormal continuously moves and collides with surrounding structures and persons.

Here, as a first comparative example of the present embodiment, for example, a configuration in which the communication state is detected based on a global positioning system (GPS) signal is considered. However, in a case where the mobile robot 30 moves in an indoor space (target space) such as a warehouse or a factory as assumed in the present embodiment, it is difficult to receive the GPS signal, and the communication state cannot be accurately detected.

In addition, as a second comparative example of the present embodiment, for example, a configuration in which the communication state is detected based on a reference signal generated on the mobile robot 30 side is considered. With such a configuration, it is possible to recognize the presence or absence of a delay occurring in wireless communication, but the operation is not normal under a situation where there is an abnormality in the communication state. In addition, in order to realize such a configuration, additional modules and arithmetic resources are required. Further, in the second comparative example of the present embodiment, it is considered that a difference between reception times of a remote operation signal and the reference signal and an integration thereof is calculated by, for example, software processing. However, in this case, a processing time from the occurrence of the abnormality to the start of handling cannot be ignored, and safe stop processing of the mobile robot 30 may be delayed (that is, a decrease in safety cannot be suppressed) due to the delay in recognition of the abnormality.

By contrast, in the present embodiment, in a case where the control signal transmitted from the information processing apparatus 10 is not received, the mobile robot 30 can be reliably stopped by detecting that the communication state is abnormal on the mobile robot 30 side.

In addition, for example, in a case where only the first mobile robot 30 (that is, the mobile robot of which the communication state is abnormal) is stopped and the second mobile robot 30 is not stopped, the second mobile robot 30 cannot avoid the first mobile robot 30 and stops in the vicinity of the first mobile robot 30. The same applies to the other mobile robots 30 moving along the same route as the first mobile robot 30. When the plurality of mobile robots 30 stop at the same place (that is, a stack occurs) as described above, the plurality of mobile robots 30 cannot smoothly start (resume) moving and may have difficulty in automatic recovery (throughput of the overall mobile robot system 1 decreases) even in a case where the abnormality in the communication state is eliminated.

By contrast, in the present embodiment, for example, in a case where the mobile robot state signal transmitted from the first mobile robot 30 is not received, the information processing apparatus 10 detects that the communication state is abnormal, and thus, the second mobile robot 30 can be stopped in advance. Accordingly, the stack can be avoided, and the decrease in throughput of the overall mobile robot system 1 can be minimized.

Note that, in the present embodiment, the first mobile robot 30 is configured to transmit the mobile robot state signal at a predetermined interval (first interval), and the processing circuit 11 of the information processing apparatus 10 generates the control signal for stopping the second mobile robot 30 in a case where the state signal is not received at the interval. In the present embodiment, the fact that the mobile robot state signal is not received at the predetermined interval (that is, the communication state is abnormal) is detected by using the timer provided in the information processing apparatus 10 (communication state detection module 112e).

Similarly, in the present embodiment, the information processing apparatus 10 is configured to transmit the control signal at a predetermined interval (second intervals), and the processing circuit 31 of the mobile robot 30 stops the mobile robot 30 based on the control signal for stopping the mobile robot 30 in a case where the control signal is not received at the interval. In the present embodiment, the fact that the control signal is not received at the predetermined interval (that is, the communication state is abnormal) is detected by using the timer provided in the mobile robot 30 (communication state detection module 31a).

In the present embodiment, with such a configuration, it is possible to detect the communication state in a short time as compared with a case where the communication state is detected by, for example, software processing.

Note that, in the present embodiment, for example, it has been described that the second mobile robot 30 is stopped in a case where the communication state of the first mobile robot 30 is abnormal. However, in a case where the second mobile robot 30 is simply stopped, there is a possibility that the second mobile robot 30 interferes with the movement of the other mobile robot 30 and the operation efficiency of the mobile robot system 1 decreases. Thus, in the present embodiment, for example, the second mobile robot 30 may move to a predetermined position (for example, a position that does not hinder the movement of the other mobile robot 30 such as near a wall surface) on the route along which the second mobile robot 30 is moving or the vicinity of the route and stopped. With such a configuration, it is possible to avoid a situation where the second mobile robot 30 collides with the other mobile robot 30 and the like, and it is possible to further improve the safety in the mobile robot system 1.

Incidentally, in a case where the abnormality of the communication state is eliminated after the first and second mobile robots 30 stop by detecting that the communication state is abnormal, for example, the movement of the first and second mobile robots 30 needs to be resumed.

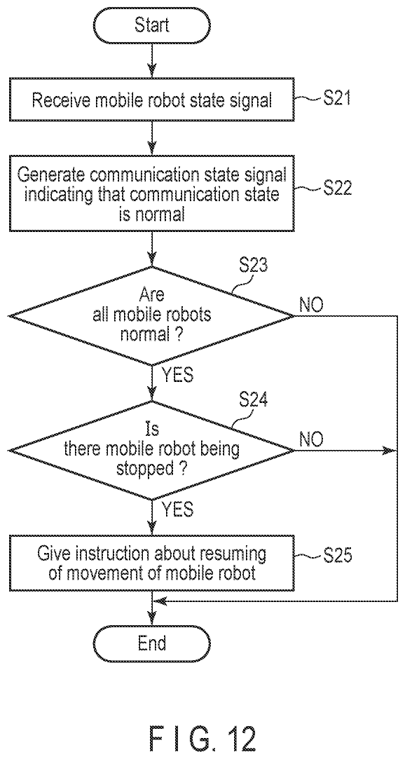

Hereinafter, an example of a processing procedure of the information processing apparatus 10 when the movement of the first and second mobile robots 30 is resumed will be described with reference to FIG. 12.

Here, it is assumed that it is detected that the communication state between the information processing apparatus 10 and the first mobile robot 30 is abnormal and at least the first and second mobile robots 30 are stopped.

First, the abnormality in the communication state between the information processing apparatus 10 and the first mobile robot 30 is eliminated, the first mobile robot 30 can receive the control signal transmitted from the information processing apparatus 10 (mobile robot control module 112) and can resume movement based on the control signal. However, even though the first mobile robot 30 receives the control signal transmitted from the information processing apparatus 10, the second mobile robot 30 cannot resume the movement.

Here, in a case where the abnormality of the communication state between the information processing apparatus 10 and the first mobile robot 30 is eliminated as described above, the information processing apparatus 10 (receiver 14) can receive the mobile robot state signal transmitted from the first mobile robot 30 (step S21).

When the processing in step S21 is executed, the communication state detection module 112e (first generation module 133) generates the communication state signal (first communication state signal) indicating that the communication state is normal as described above (step S22). The first communication state signal generated in step S22 (hereinafter, referred to as the first communication state signal of the first mobile robot 30) is notified to the overall management module 111 via the overall control module 112a.

When the processing in step S22 is executed, the overall management module 111 (the process management module 111b and the operation management module 111d) inputs the first communication state signal of the first mobile robot 30 notified from the first mobile robot control module 112.

Here, the overall management module 111 grasps the communication states (that is, the communication states between the information processing apparatus 10 and the plurality of mobile robots 30) of all the mobile robots 30 moving in the target space based on the communication state signals (first or second communication state signals) output from all the mobile robot control modules 112. In addition, the overall management module 111 grasps that the second mobile robot 30 has stopped (that is, the mobile robot 30 being stopped) due to the fact that the communication state of the first mobile robot 30 is abnormal as described above.

In this case, the overall management module 111 determines whether or not the communication states of all the mobile robots 30 moving in the target space are normal (step S23).

In a case where it is determined that the communication states of all the mobile robots 30 are normal (YES in step S23), the overall management module 111 determines whether or not there is the mobile robot 30 being stopped (step S24).

In a case where it is determined that there is the mobile robot 30 being currently stopped (YES in step S24), the overall management module 111 instructs the mobile robot control module 112 corresponding to the mobile robot 30 (here, the second mobile robot 30) to resume movement of the mobile robot 30 being currently stopped (step S25).

When the processing in step S25 is executed, the mobile robot control module 112 corresponding to the mobile robot 30 being stopped generates the control signal for moving the mobile robot 30 along the route (that is, the control signal for resuming the movement). The control signal generated as described above is transmitted to the mobile robot 30 being stopped by the transmitter 13. Accordingly, the movement of the mobile robot 30 being stopped is resumed.

Note that, in a case where it is determined that the communication states of all the mobile robots 30 are not normal (NO in step S23) or in a case where it is determined that there is no mobile robot 30 being stopped (NO in step S24), the processing illustrated in FIG. 12 is ended.

According to the processing illustrated in FIG. 12, in a case where the abnormality of the communication state of the first mobile robot 30 is eliminated and the movement of the first mobile robot 30 is resumed, the movement of the second mobile robot 30 stopped due to the abnormality of the communication state (the mobile robot 30 being stopped) can also be resumed.

Note that, in FIG. 12, it has been described that the movement of the mobile robot 30 being stopped is resumed in a case where the communication states of all the mobile robots 30 moving in the target space are normal in consideration of safety. However, for example, in a case where the communication state of the first mobile robot 30 is normal (the abnormality of the communication state is eliminated), the movement of the second mobile robot 30 moving along the same route as the first mobile robot 30 or scheduled to move along the same route may be resumed even in a case where the communication state of the other mobile robot 30 is not normal.

Incidentally, in the present embodiment, for example, it has been described that the control signal for stopping the second mobile robot 30 is transmitted to the second mobile robot 30 in a case where the communication state of the first mobile robot 30 is abnormal. However, stopping the second mobile robot 30 of which the communication state is not abnormal causes the decrease in the operation efficiency of the overall mobile robot system 1. Thus, in the present embodiment, in a case where the communication state of the first mobile robot 30 is abnormal, the route along which the second mobile robot 30 moves may be changed.

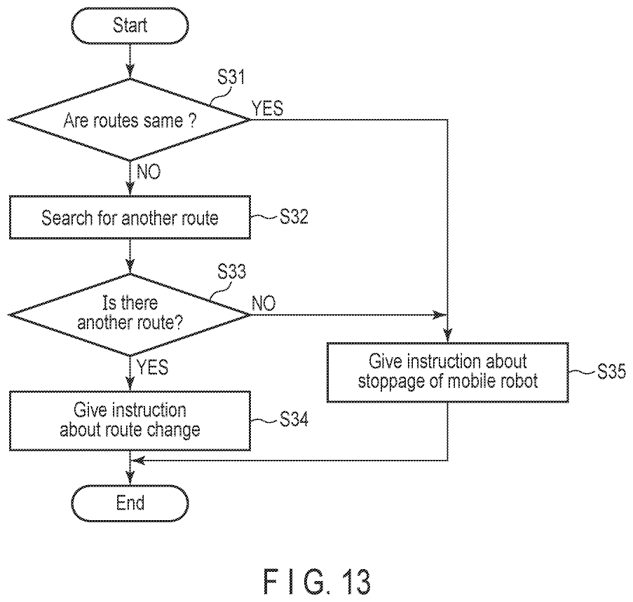

A processing procedure of the information processing apparatus 10 in a case where the route of the second mobile robot 30 is changed will be described with reference to a flowchart of FIG. 13. Note that, the processing illustrated in FIG. 13 corresponds to processing executed instead of the processing of step S5 illustrated in FIG. 7 described above.

Here, the overall management module 111 determines whether or not the route specified in step S3 illustrated in FIG. 7 (the route along which the first mobile robot 30 is moving) is the same as the route of the second mobile robot 30 specified in step S4 (step S31).

Note that, here, for example, as described above, in a case where the first mobile robot 30 and the second mobile robot 30 are moving along the same route as one route from one via-point to another via-point, it is determined in step S31 that the routes are the same. On the other hand, in a case where the second mobile robot 30 is scheduled to move along the route along which the first mobile robot 30 is moving before the second mobile robot reaches the destination but has not yet moved along the route, it is determined in step S31 that the routes are not the same.

In a case where it is determined that the routes are not the same (NO in step S31), the overall management module 111 refers to the map information stored in the map DB 123 and searches for another route capable of moving (reaching) to the destination by bypassing the first mobile robot 30 (the route along which the first mobile robot is moving) (step S32).

Subsequently, the overall management module 111 determines whether or not there is another route based on the result of the processing in step S32 (that is, the search result) (step S33).

In a case where it is determined that there is another route (that is, there is a route that bypasses the first mobile robot 30) (YES in step S33), the overall management module 111 instructs the mobile robot control module 112 (second mobile robot control module 112) corresponding to the second mobile robot 30 to change the route along which the second mobile robot 30 is scheduled to move (step S34).

When the processing in step S34 is executed, the kinds of processing in steps S6 and S7 illustrated in FIG. 7 are executed. In this case, the second mobile robot control module 112 changes the route along which the second mobile robot 30 is scheduled to move from the route along which the first mobile robot 30 is moving to the other route based on the instruction from the overall management module 111 in step S24. In other words, the second mobile robot control module 112 (movement control module 112c) generates a route different from the route along which the first mobile robot 30 is moving, and generates a control signal for moving the second mobile robot 30 along the generated route. The control signal generated as described above is transmitted to the second mobile robot 30 by the transmitter 13.

On the other hand, in a case where it is determined that the routes are the same (NO in step S31), the overall management module 111 instructs the second mobile robot control module 112 to stop the second mobile robot 30 (step S35).

When the processing in step S35 is executed, the kinds of processing in steps S6 and S7 illustrated in FIG. 7 are executed. In this case, the second mobile robot control module 112 (movement control module 112c) generates a control signal for stopping the second mobile robot 30 based on the instruction from the overall management module 111 in step S35. The control signal generated as described above is transmitted to the second mobile robot 30 by the transmitter 13.

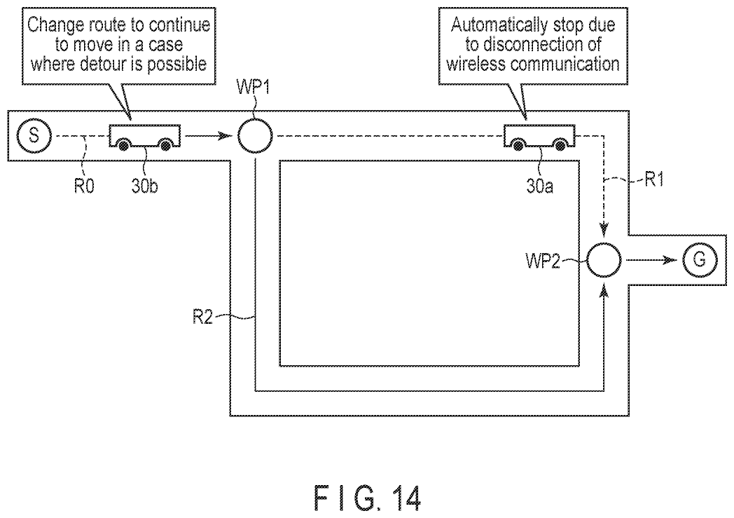

Here, the safety in the mobile robot system 1 in a case where the processing illustrated in FIG. 13 is executed will be briefly described with reference to FIG. 14. In FIG. 14, for example, it is assumed that the mobile robot 30a is moving along the route R1 from the via-point WP1 to the via-point WP2 between the departure point S and the destination G.

In a case where the mobile robot state signals transmitted from the mobile robot 30a moving along the route R1 at regular intervals are not received by the information processing apparatus 10 (receiver 14), it is detected that the communication state of the mobile robot 30a is abnormal.

In this case, when the mobile robot 30b scheduled to move along the route R1 is moving along a route R0 from the departure point S to the via-point WP1, the mobile robot 30b can reach the destination G by moving along another route R2 that bypasses the route R1.

In such a case, the route along which the mobile robot 30b is scheduled to move is changed from the route R1 to the route R2, and thus, the mobile robot 30b can reach the destination G by moving along the route R2 while preventing the communication state from becoming abnormal similarly to the mobile robot 30a by moving along the route R1, for example. Accordingly, even in a case where the communication state of the mobile robot 30a is abnormal, since it is not necessary to stop the mobile robot 30b, it is possible to suppress the decrease in the operation efficiency of the overall mobile robot system 1.

Note that, here, it is assumed that there is no branch point on the route R1 from the via-point WP1 (branch point) to the via-point WP2 (branch point) as described above. Thus, for example, in a case where the mobile robot 30b is moving along the route R1 as illustrated in FIG. 11, there is no other route that bypasses the mobile robot 30a, and the mobile robot 30b is stopped.

However, even in a case where the mobile robot 30b is moving along the route R1, for example, in a case where there is no following vehicle of the mobile robot 30b, the mobile robot 30b may be returned to the via-point WP1 to move along the route R2.

That is, whether to stop the mobile robot 30b or change the route of the mobile robot 30b may be determined in accordance with operation states of the plurality of mobile robots 30 moving in the target space.

Incidentally, in the present embodiment, it is assumed that the mobile robot system 1 is the integrated mobile robot system. In such a mobile robot system 1, the information processing apparatus 10 (MEC server) side has functions such as process management, operation management, position estimation, route generation, and movement control, and the control signal (the command regarding the moving direction, the speed, and the like) regarding the movement of the mobile robot 30 is transmitted from the information processing apparatus 10 to the mobile robot 30 by wireless communication using Wifi, LTE, local 5G (private 5G), or the like. In this case, the mobile robot 30 can move according to the control of the information processing apparatus 10 by operating an actuator such as a motor according to the control signal. On the other hand, for example, the mobile robot 30 transmits, as the mobile robot state signal, the sensor data (sensor data or the like indicating the distance measured by the LRF provided in the mobile robot 30) used for estimating the current position of the mobile robot 30 to the information processing apparatus 10. In the mobile robot system 1 according to the present embodiment, the communication state detection module 112e included in the information processing apparatus 10 detects the communication state by using the sensor data, and, for example, the communication state detection module 31a included in the mobile robot 30 achieves improvement in safety in an environment in which the plurality of mobile robots 30 move in the target space by detecting the communication state by using the control signal. Note that, in the present embodiment, it has been described that the communication state is detected by using the sensor data transmitted from the mobile robot 30 to the information processing apparatus 10. However, instead of the sensor data, heartbeat signals transmitted from the mobile robot 30 to the information processing apparatus 10 at regular intervals may be used to notify that the mobile robot 30 is active. Further, in the present embodiment, it has been described that the communication state is detected by using the control signal regarding the movement transmitted from the information processing apparatus 10 to the mobile robot 30, but other signals transmitted at regular intervals may be used instead of the control signal.

Further, in the present embodiment, it is assumed that the mobile robot system 1 is the integrated mobile robot system, but the mobile robot system 1 may be an autonomous distributed mobile robot system. While the mobile robot 30 moves according to the control signal transmitted from the information processing apparatus 10 in the integrated mobile robot system, the autonomous distributed mobile robot system is different from the aggregated mobile robot system in that the mobile robot 30 autonomously moves. In a case where the present embodiment is applied to the autonomous distributed mobile robot system, for example, the communication state detection module 112e included in the information processing apparatus 10 may operate to detect the communication state by using the heartbeat signals transmitted from the mobile robot 30 at regular intervals, and the communication state detection module 31a included in the mobile robot 30 may operate to detect the communication state by using predetermined signals transmitted from the information processing apparatus 10 at regular intervals.

Note that, in the present embodiment, it has been described that both the information processing apparatus 10 and the mobile robot 30 include the communication state detection modules. However, for example, even in a configuration in which only one of the information processing apparatus 10 and the mobile robot 30 includes the communication state detection module, the safety in the mobile robot system 1 can be improved. In other words, the present embodiment may be the mobile robot system 1 configured such that the communication state detection module is included only in one of the information processing apparatus 10 and the mobile robot 30.

In addition, in the present embodiment, it has been described that the information processing apparatus 10 includes the transmitter 13 and the receiver 14, but the information processing apparatus 10 according to the present embodiment may have a configuration in which the transmitter 13 and the receiver 14 are arranged outside.

While certain embodiments have been described, these embodiments have been presented by way of example only, and are not intended to limit the scope of the inventions. Indeed, the novel embodiments described herein may be embodied in a variety of other forms; furthermore, various omissions, substitutions and changes in the form of the embodiments described herein may be made without departing from the spirit of the inventions. The accompanying claims and their equivalents are intended to cover such forms or modifications as would fall within the scope and spirit of the inventions.

With regard to the above-described embodiments, the following supplementary notes are further disclosed.

[1]

An information processing apparatus including:
a first processing circuit configured to:
specify a first route along which a first mobile object is moving in a case where a state signal regarding a state of the first mobile object moving based on a first control signal regarding movement of the first mobile object is not received,
specify a second mobile object different from the first mobile object based on the specified first route, and
generate a second control signal regarding movement of the specified second mobile object.
   [2]

The information processing apparatus according to item 1, wherein
the first processing circuit is configured to specify a second mobile object moving along the specified first route or a second mobile object scheduled to move along the specified first route, and
the second control signal includes a signal for stopping the second mobile object.
   [3]

The information processing apparatus according to item 1 or 2, wherein
the first processing circuit is configured to specify a second mobile object scheduled to move along the specified first route, and
the second control signal includes a signal for changing a first route along which the second mobile object is scheduled to move to a second route different from the first route.
   [4]

The information processing apparatus according to item 3,
wherein the first processing circuit is configured to:
determine whether or not there is a second route capable of moving to a destination of the second mobile object by bypassing the first route,
generate, as the second control signal, a signal for stopping the second mobile object in a case where it is determined that there is no second route, and
generate, as the second control signal, a signal for changing the first route along which the second mobile object is scheduled to move to the second route in a case where it is determined that there is the second route.
   [5]

The information processing apparatus according to any one of items 1 to 4,
wherein the first processing circuit is configured to specify a second mobile object moving along the specified first route or a second mobile object scheduled to move along the specified first route, and
the second control signal includes a signal for moving the second mobile object to a predetermined position and stopping the second mobile object at the predetermined position.
   [6]

The information processing apparatus according to any one of items 1 to 5,
wherein the first mobile object is configured to transmit the state signal at a predetermined first interval, and
the first processing circuit is configured to generate the second control signal in a case where the state signal is not received at the predetermined first interval.
   [7]

The information processing apparatus according to any one of items 1 to 6, wherein the first processing circuit is configured to generate a third control signal for resuming the movement of the second mobile object in a case where the state signal is received from the first mobile object after the second control signal is transmitted to the second mobile object.

[8]

The information processing apparatus according to any one of items 1 to 7, further including;
a receiver configured to receive the state signal; and
a transmitter configured to transmit the first and second control signals.
   [9]

A system including:
the information processing apparatus according to any one of items 1 to 8; and
the first and second mobile objects.
   [10]

The system according to item 9, wherein the first mobile object includes a second processing circuit configured to control the first mobile object based on a third control signal for stopping the first mobile object in a case where the first control signal is not received.

[11]

The system according to item 10, wherein
the first control signal is transmitted at a predetermined second interval, and
the second processing circuit is configured to control the first mobile object based on the third control signal in a case where the first control signal is not received at the predetermined second interval.
   [12]

A mobile object that moves in a target space together with another mobile object based on a first control signal generated in an information processing apparatus, the mobile object including:
a processing circuit configured to control the mobile object based on a second control signal for stopping the mobile object in a case where the first control signal is not received.
   [13]

A method executed by an information processing apparatus, including:
specifying a first route along which a first mobile object is moving in a case where a state signal regarding a state of the first mobile object moving based on a first control signal regarding movement of the first mobile object is not received;
specifying a second mobile object different from the first mobile object based on the specified first route; and
generating a second control signal regarding movement of the specified second mobile object.
   [14]

A non-transitory computer-readable storage medium having stored thereon a program which is executed by a computer of an information processing apparatus, the program including instructions capable of causing the computer to execute functions of:
specifying a first route along which a first mobile object is moving in a case where a state signal regarding a state of the first mobile object moving based on a first control signal regarding movement of the first mobile object is not received;
specifying a second mobile object different from the first mobile object based on the specified first route; and
generating a second control signal regarding movement of the specified second mobile object.

What is claimed is:

1. An information processing apparatus comprising:
a first processing circuit configured to:
specify a first route along which a first mobile object is moving in a case where a state signal regarding a state of the first mobile object moving based on a first control signal regarding movement of the first mobile object is not received,
specify a second mobile object different from the first mobile object based on the specified first route, and
generate a second control signal regarding movement of the specified second mobile object.

2. The information processing apparatus according to claim 1, wherein
the first processing circuit is configured to specify a second mobile object moving along the specified first route or a second mobile object scheduled to move along the specified first route, and
the second control signal includes a signal for stopping the second mobile object.

3. The information processing apparatus according to claim 1, wherein
the first processing circuit is configured to specify a second mobile object scheduled to move along the specified first route, and
the second control signal includes a signal for changing a first route along which the second mobile object is scheduled to move to a second route different from the first route.

4. The information processing apparatus according to claim 3,
wherein the first processing circuit is configured to:
determine whether or not there is a second route capable of moving to a destination of the second mobile object by bypassing the first route,
generate, as the second control signal, a signal for stopping the second mobile object in a case where it is determined that there is no second route, and
generate, as the second control signal, a signal for changing the first route along which the second mobile object is scheduled to move to the second route in a case where it is determined that there is the second route.

5. The information processing apparatus according to claim 1,
wherein the first processing circuit is configured to specify a second mobile object moving along the specified first route or a second mobile object scheduled to move along the specified first route, and
the second control signal includes a signal for moving the second mobile object to a predetermined position and stopping the second mobile object at the predetermined position.

6. The information processing apparatus according to claim 1,
wherein the first mobile object is configured to transmit the state signal at a predetermined first interval, and
the first processing circuit is configured to generate the second control signal in a case where the state signal is not received at the predetermined first interval.

7. The information processing apparatus according to claim 1, wherein the first processing circuit is configured to generate a third control signal for resuming the movement of the second mobile object in a case where the state signal is received from the first mobile object after the second control signal is transmitted to the second mobile object.

8. The information processing apparatus according to claim 1, further comprising;
a receiver configured to receive the state signal; and
a transmitter configured to transmit the first and second control signals.

9. A system comprising:
the information processing apparatus according to claim 1; and
the first and second mobile objects.

10. The system according to claim 9, wherein the first mobile object includes a second processing circuit configured to control the first mobile object based on a third control signal for stopping the first mobile object in a case where the first control signal is not received.

11. The system according to claim 10, wherein
the first control signal is transmitted at a predetermined second interval, and
the second processing circuit is configured to control the first mobile object based on the third control signal in a case where the first control signal is not received at the predetermined second interval.

12. A mobile object that moves in a target space together with another mobile object based on a first control signal generated in an information processing apparatus, the mobile object comprising:
a processing circuit configured to control the mobile object based on a second control signal for stopping the mobile object in a case where the first control signal is not received.

13. A method executed by an information processing apparatus, comprising:
specifying a first route along which a first mobile object is moving in a case where a state signal regarding a state of the first mobile object moving based on a first control signal regarding movement of the first mobile object is not received;
specifying a second mobile object different from the first mobile object based on the specified first route; and
generating a second control signal regarding movement of the specified second mobile object.

14. A non-transitory computer-readable storage medium having stored thereon a program which is executed by a computer of an information processing apparatus, the program comprising instructions capable of causing the computer to execute functions of:
specifying a first route along which a first mobile object is moving in a case where a state signal regarding a state of the first mobile object moving based on a first control signal regarding movement of the first mobile object is not received;
specifying a second mobile object different from the first mobile object based on the specified first route; and
generating a second control signal regarding movement of the specified second mobile object.
